(19) United States
(12) Patent Application Publication
(10) Pub. No.: US 2026/0313019 A1
(43) Pub. Date: Oct. 8, 2026

(54) PRE-SCHEDULED ALLOCATION OF NETWORK RESOURCES WITH ACCURATE RUNTIME ESTIMATION OF COMMUNICATION TIME

(71) Applicant: XILINX, INC., San Jose, CA (US)

(72) Inventor: Mario BALDI, Harpswell, ME (US)

(21) Appl. No.: 18/977,658

(22) Filed: Dec. 11, 2024

(51) Int. Cl. H04L 67/1004

(52) U.S. Cl. CPC H04L 67/1004

(57) ABSTRACT

Embodiments herein describe a method including estimating a data readiness time interval, estimating a network resource reservation readiness time interval, issuing a resource reservation request at a time when the estimated data readiness time interval and the estimated network resource reservation readiness time interval are determined indicating a resource reservation can be completed before the end of the data readiness time interval, and allocating network resources on an end-to-end path when a resource reservation confirmation is issued.

### TECHNICAL FIELD

Examples of the present disclosure generally relate to networks, and, in particular, to a pre-scheduled allocation of network resources with accurate runtime estimation of communication time.

### BACKGROUND

Packet networks are the foundation of modern communication systems, enabling end systems such as computers, servers, and Internet-of-Things (IoT) devices to transmit data across interconnected networks. In these networks, data is divided into smaller packets, each of which is independently routed to its destination. However, as multiple end systems compete for shared network resources, such as bandwidth, buffer space, and processing power, contention can arise, leading to potential congestion.

To address this, packet networks rely on congestion control algorithms designed to manage and mitigate the effects of congestion. These algorithms dynamically adjust the rate at which packets are sent based on network conditions, attempting to prevent overwhelming the network and ensure that data flows as efficiently and as fairly as possible. By intelligently managing data transmission, congestion control algorithms help maintain optimal network performance, reduce packet loss, and minimize delays, ensuring a reliable and consistent communication experience for all users. However, such congestion control algorithms are either too reactive resulting in inefficient use of the network or too slow in reacting resulting in excessive latency and possible packet loss.

### SUMMARY

One embodiment described herein is a network or system including a plurality of network resources providing data transmission between a plurality of source end points and a plurality of destination end points, wherein a first source end point transmits data to a first destination end point, at a common time reference, when a time at which the first source end point is ready to transmit the data is considered close by estimating a data readiness time interval, estimating a network resource reservation readiness time interval, issuing a resource reservation request at a time when the estimated data readiness time interval and the estimated network resource reservation readiness time interval are determined indicating a resource reservation can be completed before the end of the data readiness time interval, and allocating network resources on an end-to-end path when a resource reservation confirmation is issued.

One embodiment described herein is a method including estimating a data readiness time interval, estimating a network resource reservation readiness time interval, issuing a resource reservation request at a time when the estimated data readiness time interval and the estimated network resource reservation readiness time interval are determined indicating a resource reservation can be completed before the end of the data readiness time interval, and allocating network resources on an end-to-end path when a resource reservation confirmation is issued.

One embodiment described herein is a network or system including network resources configured to be allocated, at a common time reference between source and destination end points, on an end-to-end path by at least estimating a data readiness time interval, and issuing a resource reservation request when a time at which the resource reservation can be completed is close to the estimated data readiness time interval.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a fat-tree network fabric, according to an example.

FIG. 2 illustrates the fat-tree network fabric of FIG. 1 where a reservation is made for resources (such as links, processing power, and buffer space) needed to move data between end point A and end point B, according to an example.

FIG. 3 illustrates the fat-tree network fabric of FIG. 1 where a reservation is made between end point E and end point G on a first path, according to an example.

FIG. 4 illustrates the fat-tree network fabric of FIG. 1 where a reservation is made between end point E and end point G on a second path, according to an example.

FIG. 5 illustrates the fat-tree network fabric of FIG. 1 where a reservation is made between end point C and end point H, according to an example.

FIG. 6 illustrates the fat-tree network fabric of FIG. 1 where a reservation between end point D and end point G is postponed, according to an example.

FIG. 7 illustrates the fat-tree network fabric of FIG. 1 where the reservation between end point D and end point G is enabled after postponement until a previous reservation made between end point E and end point G has been released, according to an example.

FIG. 8 illustrates the fat-tree network fabric of FIG. 1 where a reservation between end point F and end point I is postponed, according to an example.

FIG. 9 illustrates the fat-tree network fabric of FIG. 1 where a blocking scenario takes place, according to an example.

FIG. 10 illustrates a network for making resource reservations, according to an example.

FIG. 11 is a block diagram of a data processing unit (DPU) that may be used to implement a network interface controller/card (NIC), in accordance with some embodiments.

FIG. 12 illustrates a method for making resource reservations, according to an example.

FIG. 13 illustrates a method for estimating a time at which an operation will be completed based on knowledge of the computations to be performed and on monitoring the computation progress, according to an example.

FIG. 14 is a block diagram for maximizing network resource utilization while minimizing latency, in accordance with some embodiments.

FIG. 15 is a block diagram with the functionalities for balancing between efficient resource utilization and communication latency, in accordance with some embodiments.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Packet networks are communication systems where data is transmitted in small units called packets. These packets include not only the payload (the actual data being sent) but also headers with control information like the source and destination addresses, sequence numbers, and error-checking codes. Packet networks enable the efficient transmission of data across interconnected networks. Packets can take different paths to reach the destination, depending on network conditions. Switches in the network use algorithms to determine the best path for each packet. The switches can be referred to as routers or nodes or network nodes. Data is sent as soon as it is available without needing to wait for the entire message to be prepared. This supports bursty data flows.

Congestion control algorithms are mechanisms used in packet networks to deal with network congestion, which occurs when the demand for network resources exceeds the available capacity, leading to packet loss, delays, and reduced network performance.

A network fabric refers to the underlying network architecture that interconnects multiple end systems, such as servers, storage devices, and network appliances, in a data center or across a distributed computing environment. The term “fabric” is used to describe the intricate and flexible mesh of connections, much like threads in a woven fabric, enabling high-speed, scalable, and resilient communication between devices. Components of a network fabric include end systems (hosts), switches and routers, interconnects and links, topology, network protocols, and fabric management.

End systems (hosts) are devices that generate and consume data within the network. End systems can include servers, workstations, storage devices, network switches, routers, and other appliances. In a data center, end systems often host applications, databases, and services that require fast and reliable communication with other systems.

Switches serve as the primary building blocks of a network fabric. They connect end systems to the network and to each other, enabling the exchange of data. In high-performance environments, switches are often deployed in a leaf-spine topology to ensure low-latency and high-throughput connections. Switches are responsible for determining the best path for data to travel between end systems across potentially diverse and complex network paths.

Interconnects and links are the physical or logical connections between switches and end systems. Interconnects can be fiber-optic cables, copper cables, or wireless links, depending on the network's requirements for speed, distance, and reliability.

The physical arrangement of the network fabric determines its topology. Common topologies include leaf-spine, mesh, and fat-tree topology. The leaf-spine topology is a two-tier architecture where leaf switches connect directly to end systems, and spine switches interconnect the leaf switches. This topology provides predictable performance and scalability, ideal for data centers. The mesh topology is where every device is interconnected with multiple paths, providing high redundancy and fault tolerance. The fat-tree topology is a type of Clos network, which is a highly efficient, scalable network design commonly used in data centers. The fat-tree topology provides multiple paths between any pair of nodes to ensure high bandwidth and redundancy. The fat-tree topology includes a hierarchical arrangement of switches and routers organized into three layers, that is, edge, aggregation, and core. Each layer interconnects with the other layers, allowing for optimal load distribution and minimal congestion.

Packet networks traditionally rely on end points sending data into the network whenever they are ready to send such data and using congestion control algorithms to react to instantaneous congestion resulting from contention for network resources. Such congestion control algorithms are likely to either be too reactive, thus resulting in inefficient use of the network (links are not fully utilized), or too slow in reacting, thus resulting in growth of buffers in network nodes leading to excessive latency and possibly packet loss.

In view of such challenges, the example embodiments present a method and system for coordinating access to an interconnection fabric that avoids congestion, thus enabling maximum efficiency for data transfers. The method and system rely on reserving in advance one or more end-to-end paths for a given time interval and the end host beginning transmission when the reservation starts. Factors for achieving maximum network resource utilization include advanced knowledge of when the communication is supposed to start, advanced knowledge of how much data is to be transferred, and availability of a common time reference among the end host network interface cards (NICs) that is necessary to ensure proper operation. The first two factors can be obtained in artificial intelligence (AI) training and inference workloads, while the third factor can be used also for other purposes, such as event correlation for management purposes. As such, a reservation is made in advance to the data exchange starting, so that resources are available and reserved by when the communication begins. However, this is effective only starting at the time the communication is expected to begin, so that reserved resources do not sit idle (i.e., other reserved data exchanges can use them). Best effort data can be transmitted by end systems and forwarded by switches when a reservation is not in place or when a reservation is in place, but data of the corresponding data exchange is not being transmitted or forwarded.

The examples involve a reservation service that can be either centralized or distributed. Most fabrics already leverage controllers and in a possible implementation the reservation service can be collocated with the controller. In one example, the controller is implemented in one or more dedicated systems connected to the network. In another example, the controller is implemented in one or more network nodes (switch or end host). In yet another example, the reservation service is fully distributed and implemented in various network nodes. A common time reference among the end hosts is provided to trigger the beginning of transmission at the time reservation actually begins. A protocol between end hosts and the reservation service to request resource reservations and receive confirmation that network resources have been reserved and when is also presented.

The examples further involve a method for achieving maximum network resource utilization while minimizing latency. The examples show how to allocate network resources exactly at the time when a source is ready to transmit by instrumenting the application that needs to use the communication services with a system that monitors the progress of the computation being performed and estimates the instant in time S at which the data to be transferred is going to be ready. The accuracy of such estimate is higher as the computation completion time, namely data availability time, is approached. The examples show how to allocate network resources exactly at the time when a source is ready to transmit by estimating the time A needed to perform a resource reservation and triggering the resource reservation at the instant in time S-A-e, where “e” is the safety margin, to take into account the uncertainty on the estimated S and A such that the allocation will be completed just before the data will actually be ready, i.e., the actual transmission time. The examples thus minimize the time during which resources are allocated, but not used (thus maximizing network efficiency) and the time between when the data is ready and when transmission begins (thus minimizing latency).

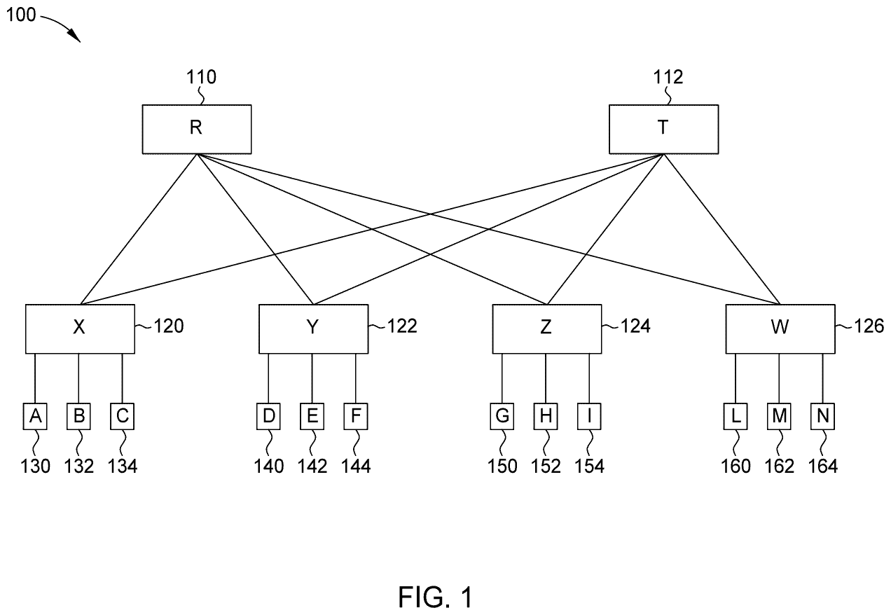

FIG. 1 illustrates a fat-tree network fabric, according to an example.

In one example, the network 100 is a fat-tree network fabric. The network 100 includes a first core switch 110 (switch R) and a second core switch 112 (switch T). The first core switch 110 and the second core switch 112 are each connected to a plurality of access switches. In one example, the first core switch 110 and the second core switch 112 are connected to a first access switch 120 (switch X), a second access switch 122 (switch Y), a third access switch 124 (switch Z), and a fourth access switch 126 (switch W). Each access switch is coupled to a plurality of end points. In one example, the first access switch 120 is coupled to a first end point 130 (end point A), a second end point 132 (end point B), and a third end point 134 (end point C). The second access switch 122 is coupled to a first end point 140 (end point D), a second end point 142 (end point E), and a third end point 144 (end point F). The third access switch 124 is coupled to a first end point 150 (end point G), a second end point 152 (end point H), and a third end point 154 (end point I). The fourth access switch 126 is coupled to a first end point 160 (end point L), a second end point 162 (end point M), and a third end point 164 (end point N).

The core switches can also be referred to as spine switches. Core (or spine) switches are usually located at the top of the network hierarchy, handling the majority of the network's data traffic between various segments or larger switches. They serve as the backbone of the network. The core switches primarily focus on high-speed data forwarding and aggregation. Their job is to ensure that data gets from point A to point B as efficiently as possible. Core (or spine) switches are designed for low-latency and high-bandwidth connections. They handle heavy traffic loads, such as in data centers or large enterprise networks, and connect to distribution switches or leaf switches. Thus, the core switches handle the heavy lifting of aggregating data and ensuring fast, reliable transport across the network fabric.

The access switches can also be referred to as leaf switches. Access (or leaf) switches are located at the edge of the network, closer to the end devices (e.g., computers, phones, IoT devices). They form the first point of connection for client devices. The access switches provide connectivity between end devices and the core of the network. They handle user traffic, offering access control. Access (or leaf) switches handle traffic from end devices and forward the traffic upstream to the core/spine switches. They may also perform tasks such as enforcing security policies. Thus, access leaves provide network access to end devices.

The end devices in the network 100 are devices that serve as the origin or destination of data. These devices may be used by end-users. End devices may be computers, laptops, workstations, servers, smart phones, tablets, printers, scanners, IoT devices, wireless access points, sensors, etc.

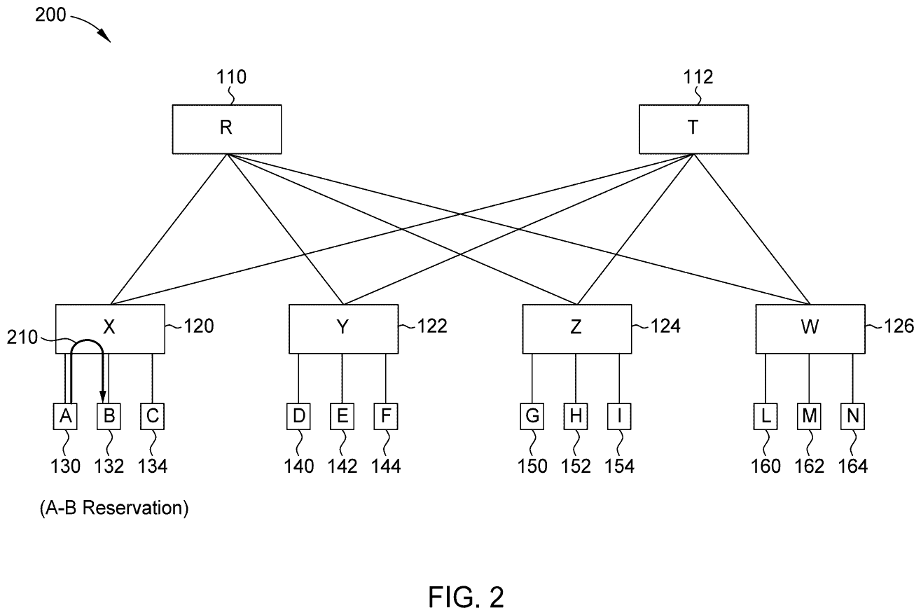

FIG. 2 illustrates the fat-tree network fabric of FIG. 1 where a reservation is made for resources (such as links, processing power, and buffer space) needed to move data between end point A and end point B, according to an example.

In diagram 200, given the fat-tree network fabric of FIG. 1, if end point A needs to send data to end point B, and end point C needs to send data to end point H, and end point E needs to send data to end point G at the same (or overlapping) time, reservations are performed. In the example embodiments, when an application or end point needs to use the network 100, resources are reserved (such as links, processing power, and buffer space) to enable such communication between a source end point and a destination end point in the network 100. The request specifies a source of the data, a destination of the data, an amount of data to be exchanged, and a time at which the data is ready to be sent. The time is expressed according to a common time reference that all end points share.

Reserving resources in a network is the process of allocating specific network resources, such as link transmission capacity, processing power, and buffer space, in advance to ensure that data can be transmitted smoothly (without contention for resources or with minimal contention) and without interruption for a specific task or application. Reserving an end-to-end path in advance for a given time interval means dedicating network resources along the entire path from the source to the destination for a predefined time period. This may involve reserving a specific amount of bandwidth on every link in the path, ensuring that the data can be transmitted without delay. This may also involve allocating buffer space on routers and switches along the path to handle potential temporary contention generated by bursts of traffic and avoid packet loss. By reserving resources, the network 100 can offer predictable and consistent performance, avoiding congestion related issues.

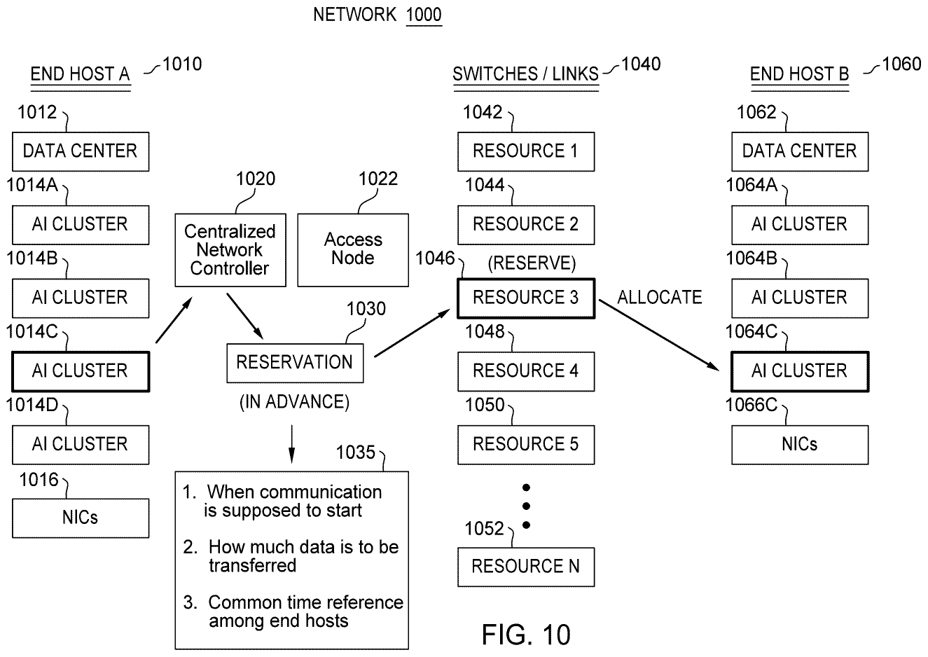

At least two scenarios, as well as a combination of them, are possible for the handling of the resource reservation. In one scenario, the request is sent to a centralized network controller that keeps track of the availability status of all resources in the network 100. In another scenario, the request is sent to an access node that forwards it to one or more other nodes in the network, where each node keeps track of the availability status of its own resources or of the resources of a subset of the network. This will be described in further detail below with reference to FIG. 10.

As such, network resources that can be reserved and the availability status of which is tracked include, but are not limited to, network links, switching paths internally to a node, buffers within nodes, computation resources within nodes, etc. Upon a request for data exchange, the centralized network controller or the set of network nodes involved in the reservation, allocate resources on one or more paths between the source and the destination. In an example, the minimum link capacity to be allocated is a whole link capacity. The reservation has a time validity that starts at the time specified in the request (preferable) or later (which adds additional latency). The start and end time of the reservation are communicated to the requesting end host in a resource confirmation message.

The number of reserved paths and the reservation time depend on resource availability and reservation policies. If the capacity of the source or destination access link is equal to or smaller than the capacity of links on the path, there is no advantage in reserving more than one link, which would result in decreased efficiency in the utilization of network resources. If the access link capacity is smaller than the capacity of the other links on the reserved path, the efficiency in network utilization is not optimal if the full link capacity of all links on the path is reserved. If source and destination have multiple access links connected to network nodes, one or more source-to-destination paths can be reserved for each of the access links.

Returning back to FIG. 2, the first end point 130 (end point A) needs to send data to the second end point 132 (end point B). In order for end point A to send data to end point B, end point A needs to make a reservation request. In an example of the A-B reservation, the links A-X and X-B are fully reserved for the data exchange from end point A to end point B, as well as enough switching and processing resources within first access switch 120 (switch X) to move the maximum amount of packets per second that can be received from link A-X to link X-B.

If resources are reserved on a single path 210 between end point A and end point B where full link capacity is reserved, the reservation A-B starts at time R_AB and ends at time E_AB=R_AB+D_AB/C_AB, where R_AB is equal or larger than S_AB, which is the desired start time included by end point A in the reservation request, D_AB is the amount of data end point A intends to send to end point B, included in the reservation request, and C_AB is the capacity of the slowest link on the path from end point A to end point B.

Transmission begins at time R_AB. It is beneficial that all end points have the same time reference to ensure that they transmit when a reservation exists for their respective data exchanges. There are multiple ways of achieving a common time reference between independent network nodes, such as using a time synchronization protocol like network time protocol (NTP) or IEEE 1588, to distribute the synchronization on dedicated interconnections among nodes, or by using external synchronization means such as global positioning system (GPS) global navigation satellite system (or GLONASS). The uncertainty in the synchronization (error in the common time reference) results in keeping a safety margin in the duration of the reservation (i.e., by having E_AB=R_AB+D_AB/C_AB+_s, where _s is dependent on the synchronization error), which results in a reduced efficiency in the utilization of network resources. In an example, _s is twice the synchronization error.

If the capacity of A's link is higher than C_AB, then, in an example behavior, end point A shapes its transmission for a capacity C_AB to avoid overloading the buffers of switches on the path. Alternatively, a congestion control mechanism can be deployed either end-to-end or on a link by link basis. However, this has higher complexity and limited efficiency, hence it is not the preferred mode of operation.

As such, to perform data transfer from end point A to end point B, the method relies on reserving, in advance, an end-to-end path for a given time interval and the end point host beginning transmission when the reservation starts. Achieving maximum network resource utilization can be accomplished by, e.g., making a request that includes advanced knowledge of when the communication is supposed to start, advanced knowledge of how much data is to be transferred, and availability of a common time reference among the end points with synchronization uncertainty small compared to the time needed to transfer the data.

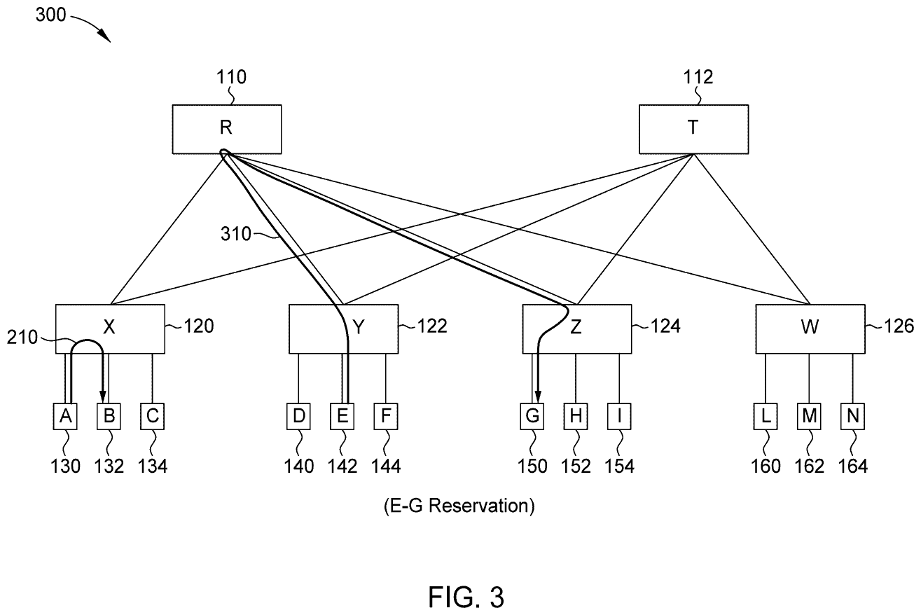

FIG. 3 illustrates the fat-tree network fabric of FIG. 1 where a reservation is made between end point E and end point G on a first path, according to an example.

In diagram 300, once new requests are issued, the corresponding resources are allocated, if available. For example, FIG. 3 shows a situation in which a path is reserved between end point E and end point G for a time frame that overlaps with the reservation for the path between end point A and end point B, i.e., R_AB<=R_EG<=E_AB or R_EG<=R_AB<=E_EG. The reservation may be designated as the E-G reservation along the path 310. The path 310 extends from the end point E to the second access switch 122 (switch Y) to the first core switch 110 (switch R) to the third access switch 124 (switch Z) to the end point G. Multiple reservations can be made between end point E and end point G.

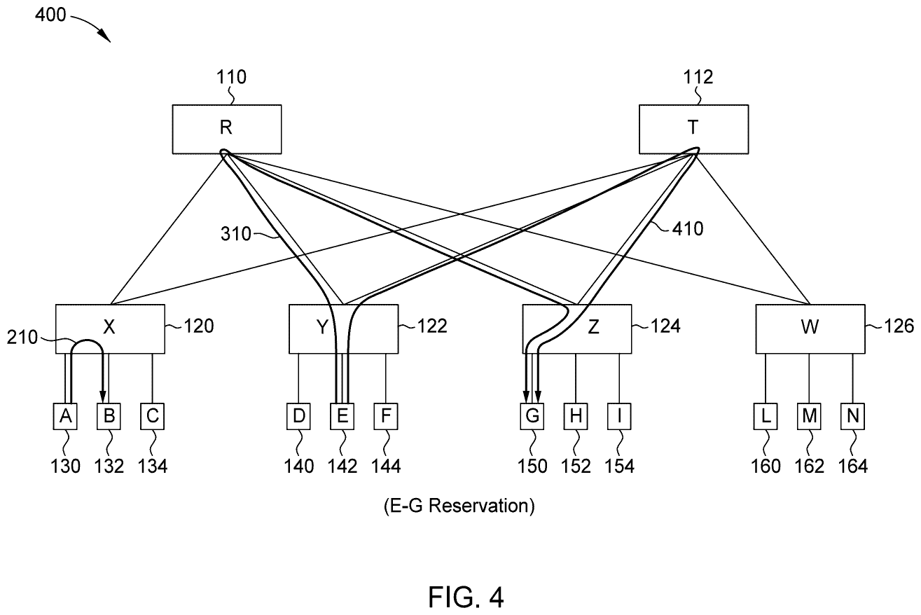

FIG. 4 illustrates the fat-tree network fabric of FIG. 1 where a reservation is made between end point E and end point G on two paths, according to an example.

In diagram 400, in an example the access links of end point E and end point G have larger capacity than the links between spine and leaf switched and two paths are allocated between E and G. The first path is from end point E to the second access switch 122 (switch Y) to the first core switch 110 (switch R), to the third access switch 124 (switch Z), to the end point G. The second path is from end point E to the second access switch 122 (switch Y) to the second core switch 112 (switch T), to the third access switch 124 (switch Z), to the end point G. The first path goes through the first core switch R (E-G reservation along the path 310) and the second path goes through the second core switch T (E-G reservation along the path 410). The first path may overlap with the path reserved for data transmitted from end point A to end point B, whereas the second path may be a path providing, e.g., more favorable network resources (e.g., higher bandwidth, less used switches, etc.). The system may select either the E-G reservation of the first path or the E-G reservation of the second path based on a predefined policy that can be based on a number of factors. Multiple reservations can be made between end point E and end point G.

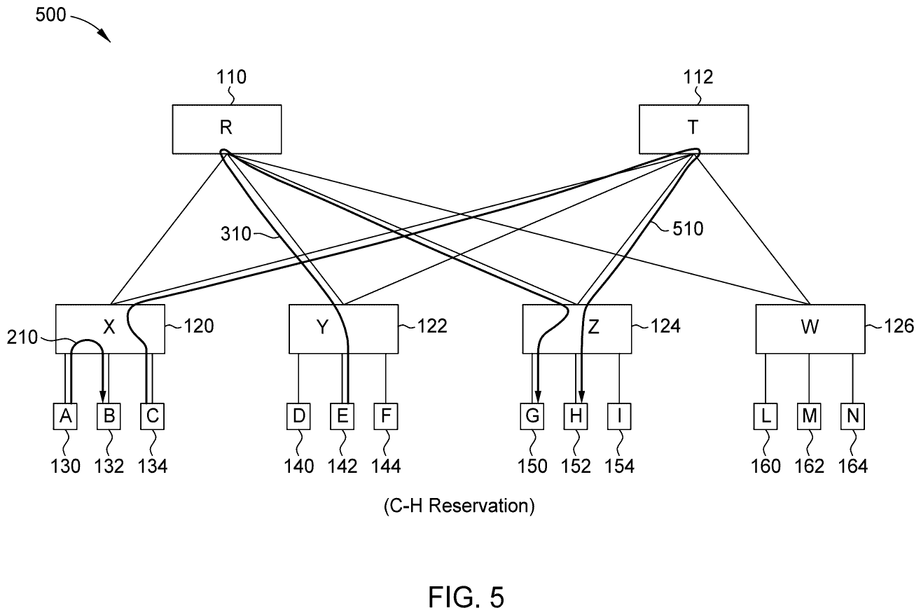

FIG. 5 illustrates the fat-tree network fabric of FIG. 1 where a reservation is made between end point C and end point H, according to an example.

In diagram 500, as more reservation requests are received, resources are allocated possibly in an overlapping way so that at some point in time several paths may be allocated through the network 100. As noted above, end point A needs to send data to end point B, and end point C needs to send data to end point H, and end point E needs to send data to end point G at the same (or overlapping) time. In FIG. 2, an A-B reservation was made to perform data transfer from end point A to end point B and in FIGS. 3-4, an E-G reservation was made to perform data transfer from end point E to end point G. In FIG. 5, after the first two reservations have been completed, the next reservation may be made to perform data transfer from end point C to end point H. The next reservation is the C-H reservation along the path 510. The path 510 is selected from end point C to the first access switch 120 (switch X) to the second core switch 112 (switch T), to the third access switch 124 (switch Z) to the end point H.

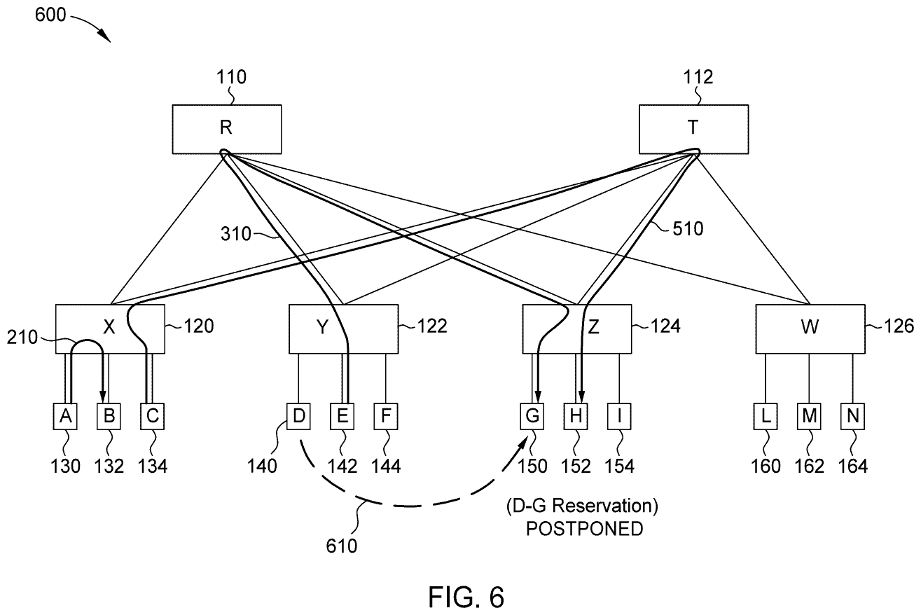

FIG. 6 illustrates the fat-tree network fabric of FIG. 1 where a reservation between end point D and end point G is postponed, according to an example.

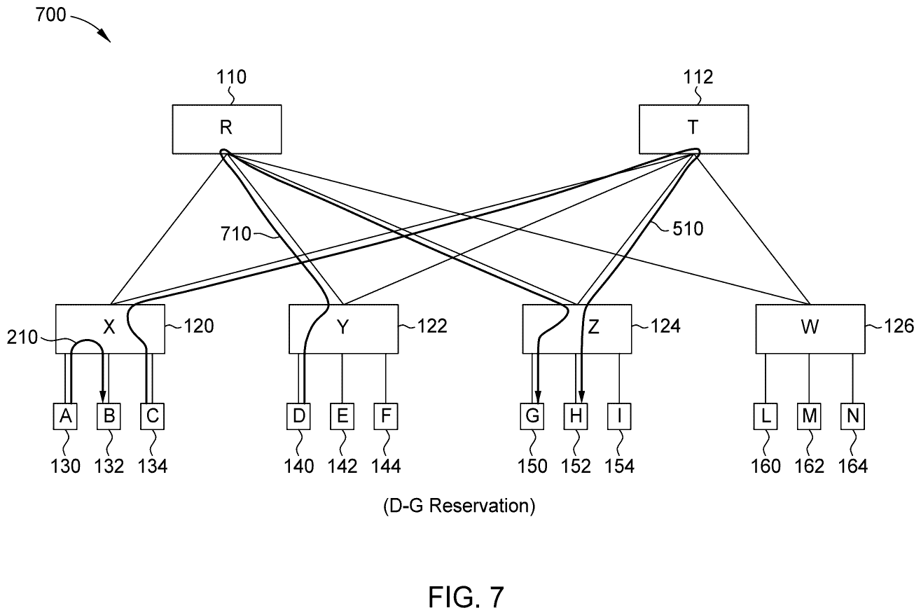

In diagram 600, ideally, a reservation begins at the time of the request, i.e., R_xy=S_xy. However, due to an instantaneous resource occupancy state, the beginning of a reservation may need to be postponed (D-G reservation postponement 610). For example, in the scenario depicted in FIG. 6, where all links have the same capacity, in the case of a request from end point D to end point G, a reservation cannot begin until G's access link becomes available, i.e., although S_DG<=E_EG, since S_DG>=R_EG, R_DG=E_EG. This leads to the allocation shown in FIG. 7 at a time following E_EG, the end of the reservation for E-G.

FIG. 7 illustrates the fat-tree network fabric of FIG. 1 where the reservation between end point D and end point G is enabled after postponement until a previous reservation made between end point E and end point G has been released, according to an example.

In diagram 700, the D-G reservation postponement 610 affects neither the efficiency in the utilization of network resources nor the communication completion time. The data exchange D-G will end at the same time it would end if D-G and E-G shared G's access link in any proportion. The performance of the system, in terms of communication completion time, is simply limited by G's access link as a limited resource. When comparing the example approach with a traditional approach of statistically sharing G's access link with a congestion control algorithm determining in which proportion, the example approach achieves higher effective transfer rate (e.g., goodput) and lower minimum and maximum completion time because the inefficiencies of using a congestion control algorithm are avoided. Inefficiencies of congestion control algorithms include, e.g., underutilization of network resources, overhead due to packet retransmission in response to packet loss, queueing delays, unfair bandwidth allocation, oscillation and instability, and inefficiencies in application-specific requirements. The D-G reservation along the path 710 takes place once the D-G reservation postponement 610 ends. The path 710 extends from the end point C to the first access switch 120 (switch X) to the second core switch 112 (switch T) to the third access switch 124 (switch Z) to the end point H.

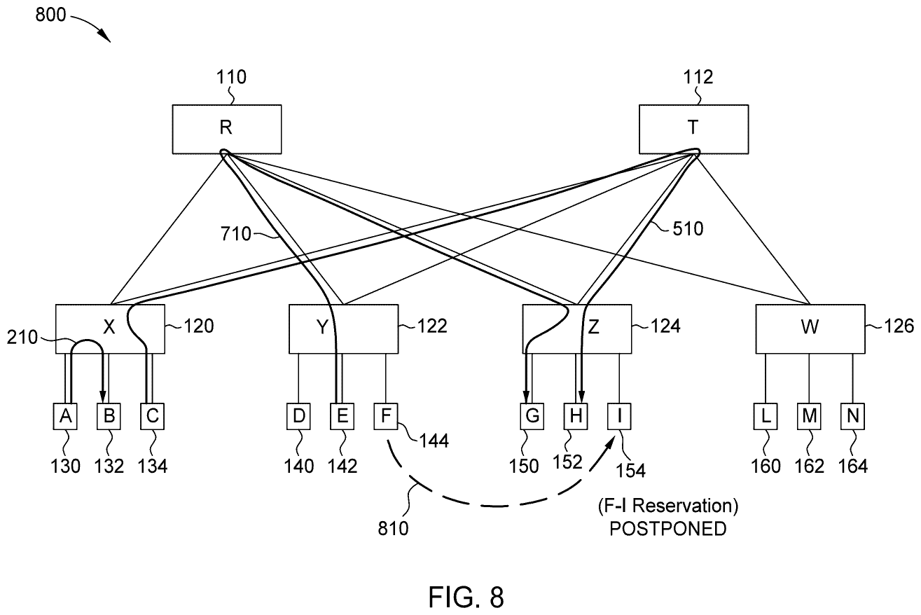

FIG. 8 illustrates the fat-tree network fabric of FIG. 1 where a reservation between end point F and end point I is postponed, according to an example.

In diagram 800, another scenario where a reservation (for a path between F and I) is postponed due to lack of resources is presented. This postponement is designated as F-I reservation postponement 810. In this case, both links from spine switches to leaf switch Z are reserved at the same time. The F-I reservation postponement 810 affects neither the efficiency in the utilization of network resources nor the communication completion time. The performance of the system, in terms of communication completion time, is simply limited by the links TZ and RZ as limited resources.

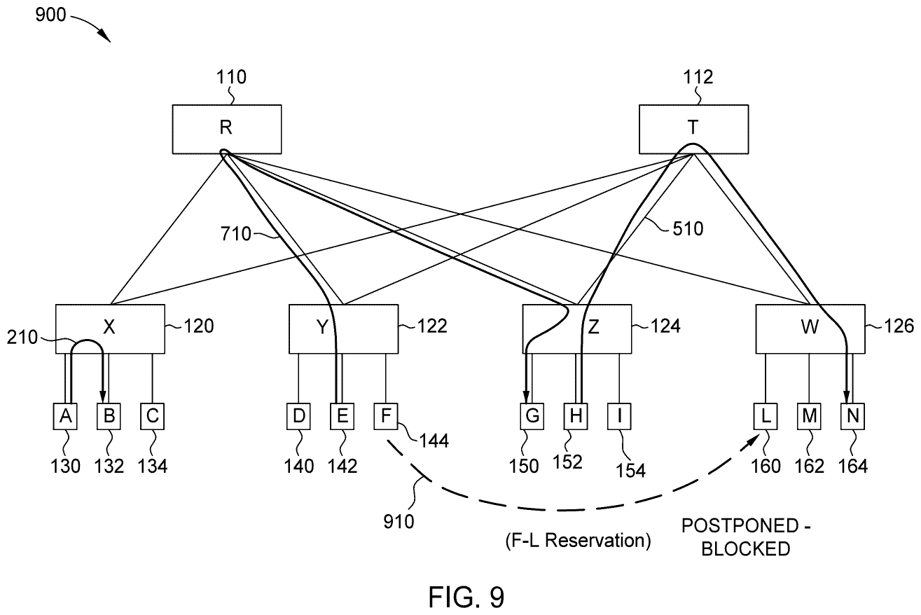

FIG. 9 illustrates the fat-tree network fabric of FIG. 1 where a blocking scenario takes place, according to an example.

In diagram 900, since a reservation (for a path between end point F and end point L) was postponed due to lack of resources, a new path (F-L reservation postponement 910) may be used between end point F and end point L. The F-L reservation postponement 910 affects the efficiency in the utilization of network resources and, as a result, the communication completion time.

The example solution has one limitation when compared with the traditional approach based on statistical multiplexing of traffic, that is, blocking. Blocking occurs when a reservation needs to be delayed although resources (e.g., unreserved links) are available in the network. This is exemplified in FIG. 9 where a request for a path between end point F and end point L cannot coexist with the reservations shown although there is enough capacity in both access links, between the second access switch 122 (switch Y) and a core switch, and between a core switch and the fourth access switch 126 (switch W).

However, access switch Y has available capacity towards core switch T, while access switch W has capacity only with regard to core switch R. A traditional solution based on packet spraying across equal cost multi-path (ECMP) routes does not suffer from this limitation because it uses both uplinks from access switch Y and both downlinks to access switch W for each of the data exchanges E-G, H-N, and F-L. However, the performance is not necessarily better because of the inherent inefficiency of dynamically sharing the resources using congestion control. In the context of the example solution, blocking can be overcome by dynamical reallocation of resources.

Therefore, according to FIGS. 1-9, each reservation is for a unidirectional data exchange and involves transmission capacity in one direction of the links. In another example, reservations for bi-directional data exchanges can be performed.

Packet delivery services in networking includes ordered delivery and reliable delivery. These services ensure that data is transmitted from one end point to another end point in an expected manner, avoiding errors and disruptions.

In ordered delivery, it is ensured that packets arrive at the destination in the same sequence in which they were sent. If a single path is reserved for a communication (which, in an example, is the case when access links have the same capacity as the other links in the network), packets are naturally delivered in order. If multiple paths are being used, reordering is needed at the destination host. Packet reordering is needed in the traditional approach based on statistical multiplexing of traffic on the links and traffic spraying across multiple links.

In reliable delivery, it is ensured that all packets sent from a source reach the destination without loss or corruption. Reliable delivery guarantees that missing packets are retransmitted and data integrity is maintained. For reliable delivery, various solutions may be employed. One solution pertains to link level reliability. Given that when a network is operated as described herein packets are not dropped due to congestion and that the likelihood of packets being corrupted inside nodes is extremely low, the “most likely” source of errors are transmission errors, which can be recovered on a link-by-link basis. Error detection and retransmission can be used on a link by link basis. Although link level reliability makes node implementations more complex, it can achieve better response time when compared with end-to-end mechanisms where each retransmission adds one round trip time (RTT) to the upper bound of latency. Another solution pertains to end-to-end reliability where error detection and retransmission mechanisms are implemented by the communication end points. Yet another solution pertains to using forward error correction to minimize the need for retransmission and its impact on latency.

In an example, acknowledgements and retransmissions are carried outside of the reservation, for example on a best effort basis if nodes have more access bandwidth than one being reserved. Alternatively, an additional amount of bandwidth can be allocated for retransmission based on the transmission error rate knowing that packets can be lost only due to transmission errors. This will involve a buffer in the sender network interface controller (NIC) to store the additional packets when retransmissions are needed and not enough instantaneous bandwidth is available. Bandwidth can be reserved in the reverse direction for acknowledgements.

Additionally, flow control may need to be used if the end systems are not able to receive data at full speed. This will affect the performance of data transfers through the fabric.

Further, hosts may need to maintain the capability to transmit best effort traffic outside of the reserved paths. This can be achieved in several possible ways. In one example, additional access links and links between switches exist that are not allocated for congestion-less (reserved) transmission. In another example, only a fraction on the capacity of the host access links and the links between switches are reserved to congestion-less traffic and the rest of the capacity can be used, at any time, for best effort transmission. In this case, hosts shape their traffic so that congestion-less traffic does not exceed the allocation (on any given shaping interval) and best effort traffic does not exceed the remaining bandwidth.

FIG. 10 illustrates a network for making resource reservations, according to an example.

In an example, a network 1000 includes an end host A (or end points 1010) and an end host B (or end points 1060). The terms end hosts, end nodes, and end points may be used interchangeably. In one example, an end point (source) needs to transmit data to another end point (destination). The end points 1010 may be, e.g., a data center 1012, artificial intelligence (AI) clusters 1014A, 1014B, 1014C, 1014D, and NICs 1016. The end points 1010 may be any type of network-accessible entity. An AI cluster is a high-performance computing system to handle intensive workloads of AL and machine learning (ML) applications. An AI cluster is a network of interconnected hardware resources working together to process large-scale data, train AI models, and run AI algorithms.

In this non-limiting example of FIG. 10, communication between a first AI cluster and a second AI cluster is described. However, the example approach of FIG. 10 can be used for communication or interconnection between hosts. A host is any device on the network that can communicate, send, or receive data. A host is capable of, e.g., running services and managing connections.

In the non-limiting example, an AI cluster 1014C wants to transmit data to an AI cluster 1064C, and a request is made either to a centralized network controller 1020 or to an access node 1022. In a similar fashion, data may need to be transmitted from end host A to end host B, or any other hosts. As such, the following description can apply equally to communication between hosts. The centralized network controller 1020 keeps track of the availability status of all resources in the network 1000. The access node 1022 forwards the request to one or more other nodes in the network 1000, where each node keeps track of the availability status of its own resources. The AI cluster 1014C needs to make a reservation 1030 before transmitting data to the AI cluster 1064C. The reservation 1030 is made in advance. The reservation 1030 may specify various parameters 1035. The parameters 1035 include, but are not limited to, when communication is supposed to start, how much data is to be transferred, and a common time reference among the end points or end hosts. When such data is provided, the reservation 1030 is made in advance, and the AI cluster 1014C is now enabled to send data to the AI cluster 1064C.

In the example, a plurality of switches 1040 connect the end points 1010 to the end points 1060. The switches 1040 include a number of resources, such as, a first resource 1042, a second resource 1044, a third resource 1046, a fourth resource 1048, a fifth resource 1050, and an N resource 1052. In the example, the third resource 1046 is reserved to enable communication from the AI cluster 1014C and the AI cluster 1064C. As such, network resources can be reserved, such as specific switches. The centralized network controller 1020 or the set of network nodes or access node 1022 involved in the reservation 30 can allocate the third resource 1046 on one or more paths between the source and the destination. The minimum link capacity to be allocated is a whole link. The reservation 1030 has a time validity that should start at the time specified in the request. The AI cluster 1014C thus is able to make a resource reservation to transmit data to one of the end points 1060, which include data center 1062, AI cluster 1064A, AI cluster 1064B, AI cluster 1064C, and NICs 1066C.

Therefore, according to FIGS. 1-10, the examples use advanced knowledge about the size, route, and timing of data exchanges to pre-allocate resources in the network for a predefined time frame, and then rely on a common time reference among end hosts or end points to start the transmission of the data at the time when the allocation time frame begins. This eliminates the need to use congestion control algorithms. This is different than known solutions that allow end hosts to start their transmissions at any time, usually without a specific resource allocation, and then rely on congestion control to handle congestion. This is further different than known solutions that use resource allocation without a predefined time frame, but have the reservation made when the at least part of the data is ready to be transmitted and released when the transmission is ended.

Instead, the examples involve a reservation service that can be either centralized or distributed. Most fabrics already leverage controllers and in a possible implementation the reservation service can be collocated with the controller. In a possible implementation the controller is implemented in one or more dedicated systems connected to the network. In another possible implementation the controller is implemented in one or more network nodes (switch or end host). In yet another possible implementation the reservation service is fully distributed and implemented in various network nodes. A common time reference among the end hosts is provided to trigger the beginning of transmission at the time reservation actually begins. A protocol between end hosts and the reservation service to request resource reservations and receive confirmation that resources have been reserved and when is also presented.

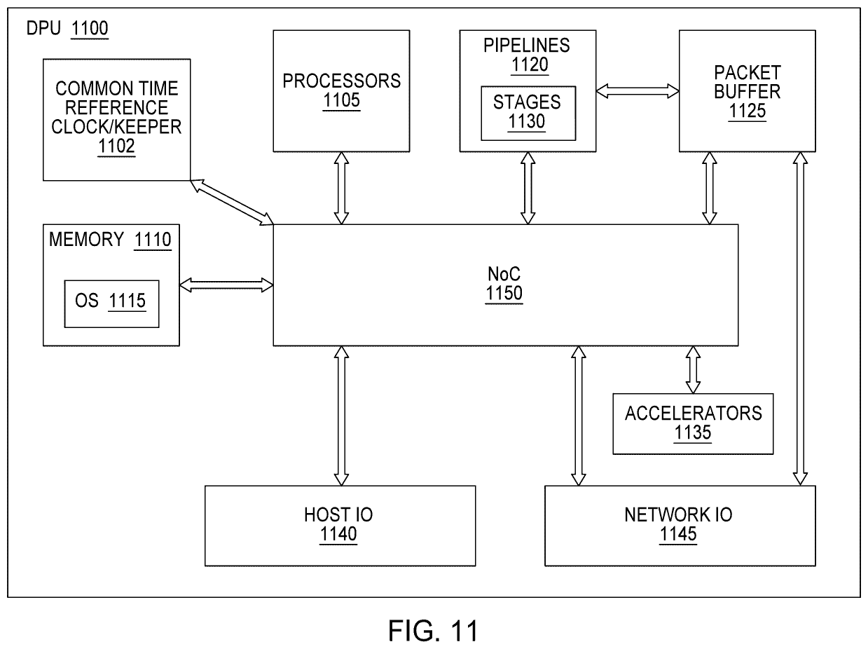

FIG. 11 is a block diagram of a data processing unit (DPU) that may be used to implement a network interface controller/card (NIC), in accordance with some embodiments.

In one embodiment, the DPU 1100 is a programmable processor designed to efficiently handle data-centric workloads such as data transfer, reduction, security, compression, analytics, and encryption, at scale in data centers. The DPU 1100 can improve the efficiency and performance of data centers by offloading workloads from a host central processing unit (CPU) or graphic processing units (GPUs). While CPUs and GPUs can specialize on compute, the DPU may specialize in data movement. The DPU 1100 can communicate with host CPUs and GPUs to enhance computing power and the handling of complex data workloads.

The DPU 1100 may also include a common time reference clock/keeper 1102 to establish a common time reference. The common time reference clock/keeper 1102 provides a unified time standard that ensures all parts of the overall system or network operate in sync. The common time reference clock/keeper 1102 may provide for synchronization, data consistency, reduced latency, and event correlation. The common time reference is established among all DPUs.

The DPU 1100 includes a plurality of processors 1105. In one embodiment, the processors 1105 include any number of processing cores. In one embodiment, the processors 1105 may be CPUs. The processors 1105 can form one or more CPU core complexes. The processors 1105 can be any hardware circuitry that uses an instruction set architecture (ISA) to process data, such as a complex instruction set computer (CISC) or reduced instruction set computer (RISC).

The memory 1110 can include volatile or non-volatile memory such as random access memory (RAM), high bandwidth memory (HBM), and the like. The memory 1110 can include an operating system (OS) 1115 that is separate from the host OS.

In one embodiment, the DPU may be in (or be used to implement) a network interface controller/card (NIC) such as a SmartNIC that processes packets before they are forwarded to a host (e.g., a host CPU or GPU). In one embodiment, the DPUs 1100 are fully programmable P4 DPUs. The DPU 1100 includes multiple pipelines 1120 (which can be the same type or different types) for processing received network packets stored in a packet buffer 1125. In this example, the pipelines 1120 has direct connections to the packet buffer 1125.

The pipelines 1120 can operate in parallel. Further, the pipelines 1120 can be the same type of pipeline (e.g., perform the same tasks). In other embodiments, the DPU 1100 may have different types of pipelines 1120. For example, the DPU 1100 could include networking pipelines which perform networking tasks such as combining packets that were subdivided to be compatible with a maximum transmission unit (MTU) or for dealing with one or more host operating systems, drivers, and/or message descriptor formats in host memory, and could also include direct memory access (DMA) pipelines which perform memory reads and writes.

The pipelines 1120 include multiple stages 1130 where received packet data is processed at each stage 1130 before being passed to the next stage. This packet data could be the entire packet or just a portion of the packet. For example, a parser in the DPU 1100, which is upstream from the pipelines 1120, may parse out a particular portion of a received packet (e.g., a packet header vector (PHV)) which is then sent to the one of the pipelines 1120.

The stages 1130 can include circuitry or hardware. In one embodiment, the stages 1130 can be programmed using a pipeline programming language, such as P4. In one example, the stages 1130 in one pipeline 1120 perform the same functions of the stages 1130 in another pipeline 1120. However, in other embodiments, the stages may perform different functions.

In addition to the stages, the pipelines 1120 may each include memory, which can be referred to as local memory. This memory can store local tables that indicate how, or if, a particular packet should be processed at the stages 1130. For example, one of the stages in the pipelines 1120 can perform a lookup to read a policing entry in a table to determine whether an entity associated with the packet has exceeded a rate limit (e.g., a packet rate limit, a data rate limit, or both).

The DPU 1100 can include accelerators 1135 to perform specialized tasks associated with data movement. The accelerators 1135 can include a cryptography accelerator, a data compression accelerator, as well as accelerators for performing regex or dedupe.

To communicate with the host and a network, the DPU 1100 includes host input/output (IO) 1140 and network IO 1145. The host IO 1140 can include a peripheral component interconnect express (PCIe) interface, or any suitable protocol for communicating with a CPU or GPU in the host. The network IO 1145 can include Ethernet interfaces, and the like for communicating with a network.

The DPU 1100 includes a network on chip (NoC) 1150 for interconnecting the various components discussed above. While a NoC is disclosed, the DPU 1100 can include any suitable on-chip network. While some components in the DPU 1100 may rely on the NoC 1150 to communicate with other components, the DPU 1100 can also include connections between components that bypass the NoC 1150. For example, the packet buffer 1125 can have a connection to the network IO 1145 that bypasses the NoC 1150. Similarly, the pipelines 1120 can exchange packet data with the packet buffer 1125 without having to rely on the NoC 1150. However, to transfer data to the processors 1005, the pipelines 1120 may use the NoC 1150.

In one embodiment, the DPU 1100 includes security and management features such as offering a hardware root of trust, secure boot, and the like.

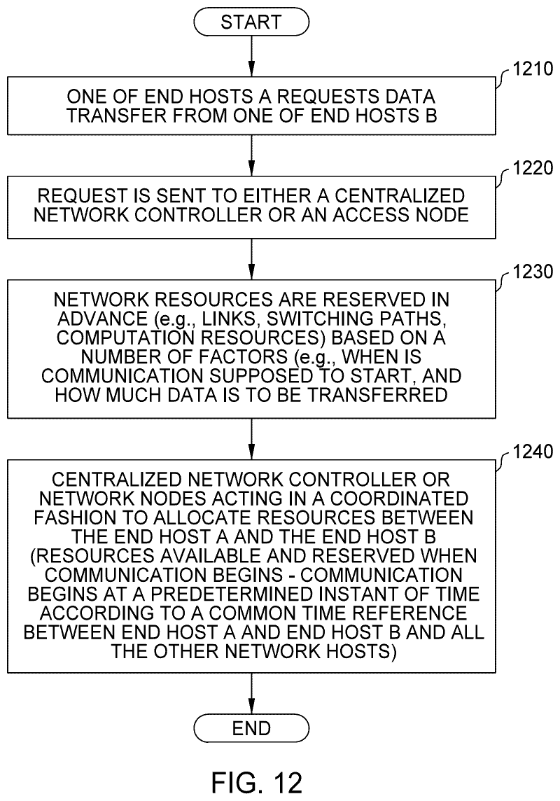

FIG. 12 illustrates a method for making resource reservations, according to an example.

At 1210, one of end hosts A requests data transfer from one of end hosts B.

At 1220, a request is sent to either a centralized network controller or an access node. The centralized network controller keeps track of the availability status of all resources in the network. The access node forwards the request to one or more other nodes in the network, where each node keeps track of the availability status of its own resources.

At 1230, network resources are reserved in advance (e.g., links, switching paths, computation resources, buffer space) based on a number of factors. Such factors include, e.g., when communication is supposed to start and how much data is to be transferred.

At 1240, a centralized network controller or network nodes acting in a coordinated fashion allocate resources between the end host A and the end host B.

Resources are available and reserved when communication begins. Communication begins at the time resources are reserved according to a common time reference between end host A and end host B, and all the other network hosts.

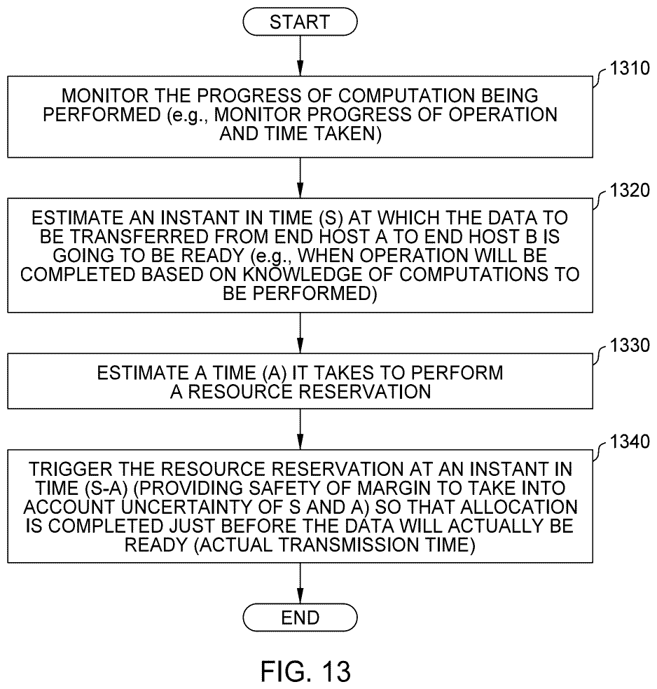

FIG. 13 illustrates a method for estimating a time at which an operation will be completed based on knowledge of the computations to be performed and on monitoring the computation progress, according to an example.

At 1310, the progress of computations being performed is monitored. For example, the progress of an operation and a time taken is monitored.

At 1320, an instant in time(S) is estimated at which the data to be transferred from end host A to end host B is ready. For example, the estimate pertains to when the operation will be completed based on knowledge of computations to be performed.

At 1330, a time (A) it takes to perform a resource reservation is estimated.

At 1340, the resource reservation at an instant in time (S-A) is triggered to provide a safety margin to take into account uncertainty of S and A such that the allocation is completed just before the data will actually be ready, which is the actual transmission time.

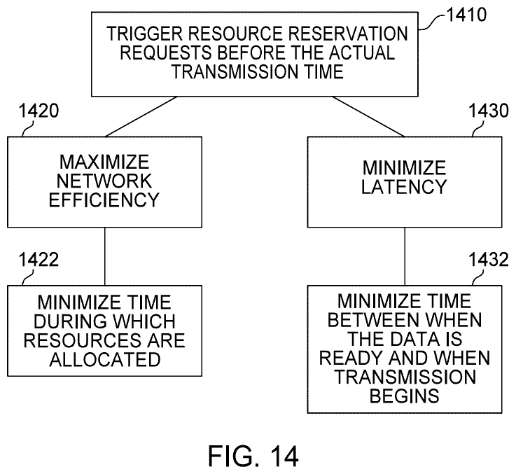

FIG. 14 is a block diagram for maximizing network resource utilization while minimizing latency, in accordance with some embodiments.

At 1410, resource reservation requests are triggered before the actual transmission time to maximize network efficiency and minimize latency. Stated differently, the resource reservation requests are triggered at a time so that the resource reservation is completed before the actual transmission time. The start time of the reservation coincides with the time that the data is ready for transmission.

At 1420, network efficiency is maximized by minimizing the time during which resources are allocated (at 1422).

At 1430, latency is minimized by minimizing the time between when the data is ready and the data transmission beings (at 1432).

A balance needs to be struck between efficient resource utilization and communication latency. If a source is ready to transmit before the resource allocation starts, it has to wait, thus experiencing increased latency. If a source is ready to transmit after the resource allocation starts, resources are kept idle, thus decreasing the efficiency in utilization. FIGS. 13 and 14 enable the start time of an allocation to be close to the time at which a source is ready to transmit.

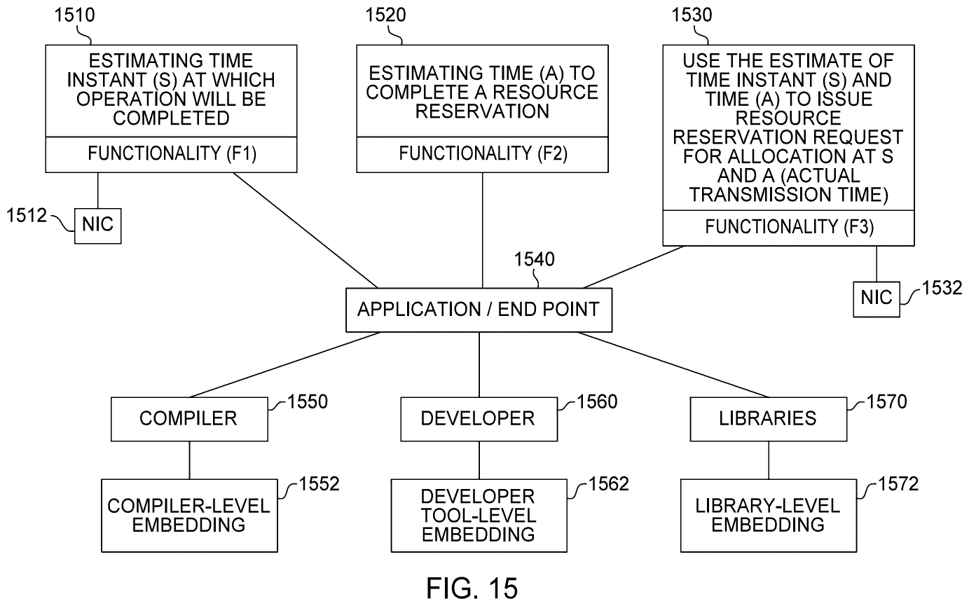

FIG. 15 is a block diagram with the functionalities for balancing between efficient resource utilization and communication latency, in accordance with some embodiments.

The block diagram provides three functionalities.

The first functionality (F1) 1510 estimates the time instant(S) at which the operation will be completed.

The second functionality (F2) 1520 estimates the time (A) to complete a resource reservation. The second functionality (F2) 1520 can be embedded in applications or it can be embedded in the communication system. In one example, the second functionality (F2) 1520 may be embedded in a network controller.

The third functionality (F3) 1530 uses the estimated time instant(S) and the time (A) to issue a resource reservation request for allocation at S and A, which is the actual transmission time. The third functionality (F3) 1530 determines that a resource reservation request for an allocation starting at S shall be issued at time S-A-e, where “e” is the safety margin, to take into account the uncertainty of S and A. This way, if resources are available, the allocation can start at a time AS, as close as possible to S.

The first functionality (F1) 1510, the second functionality (F2) 1520, and the third functionality (F3) 1530 can be embedded in an application 1540. The functionalities can be embedded by a compiler 1550, a developer 1560 or libraries 1570. The compiler 1550 includes compiler-level embedding 1552, the developer 1560 includes developer tool-level embeddings 1562, and the libraries 1570 include library-level embeddings 1572. In one example, the first functionality (F1) 1510 can be implemented by an NIC 1512 and the third functionality (F2) 1530 can be implemented by an NIC 1532. The combination of the first functionality (F1) 1510, the second functionality (F2) 1520, and/or the third functionality (F3) 1530 is different than traditional systems for controlling access and transmission to a network.

Since the estimation of S becomes more accurate the more the operation is approaching its end, the application 1540 aims at issuing a resource reservation for moving the data that will be ready at the end of the operation, as close as possible to the end of the operation itself. However, performing the resource reservation will involve a certain amount of time because the request has to reach the reservation service, available resources need to be identified (possibly including exploring one or more routes through the network), and then allocated (possibly including notifying individual nodes). FIGS. 13-15 include a methodology to avoid having the application 1540 wait for the reservation to be completed, thus increasing the latency of the data transfer.

The compiler 1550 can insert the code for the functionality interweaving it with the code of the application. Advantages of using the compiler-level embedding 1552 include providing optimizations at the compiler level that can provide significant performance improvements, as the compiler 1550 has deep insight into the code structure. A further advantage includes that automatically applied optimizations reduce the need for developer intervention. Compiler optimizations are applied uniformly across all code compiled with that toolchain.

The developer 1560 can insert the code for the functionality interweaving it with the code of the application. Advantages of using the developer tool-level embeddings 1562 include improving development efficiency by offering smart suggestions, code analysis, or automated refactoring. Tools can be configured or extended to suit specific workflows. User experience can be enhanced by integrating functionalities directly into the development environment.

The libraries 1570 deployed in the implementation of the application can include the functionalities. Advantages of using the library-level embeddings 1572 include that the libraries 1570 can be reused across multiple projects, improving development speed. The libraries 1570 provide flexibility to include or exclude functionality as needed and the libraries 1570 can offer runtime configurations and optimizations.

Thus, the compiler 1550 may be best for low-level optimizations and language-specific functionality, which impacts runtime performance significantly, the developer 1560 may be best for improving developer experience and productivity, focusing on code quality, debugging, and efficiency without runtime impact, and the libraries 1570 may be best for offering reusable, modular functionality with more runtime flexibility, though with potential performance trade-offs.

Stated differently, and referring to FIGS. 13-15, the system predicts when the source will have the data ready for transmission (estimating data readiness time). This may involve analyzing buffer status, the completion of a computation process, or a data production event. By knowing the exact instant when the data will be ready, the system avoids pre-allocating resources too early or too late, which leads to more efficient utilization of network resources. Based on factors like current network load, the distance between nodes, and the reservation mechanisms in place, the system calculates how long it will take to reserve the necessary resources (estimating network resource reservation time). This includes setting up paths, allocating bandwidth, and configuring buffers along the transmission path. The resource reservation is triggered exactly when the estimated time to transmit the data and the time required for reservation match up. This ensures that resources are allocated just in time to avoid idling but are ready by the moment the data needs to flow.

The benefits of the example approach include reducing the completion time for data exchanges, and consequently the completion time of the overall application execution. Moreover, if the timing and the amount of data to be exchanged can be known early enough to reserve network resources in advance for the required amount of time, the network efficiency is increased, thus enabling more data to be effectively exchanged on a given network compared to traditional techniques based on congestion control. In the context of AI clusters, this implies that distributed AI applications can run faster (i.e., train faster or provide faster responses when inference is performed) and larger models can be used on a given network fabric or more training and/or inference jobs can be executed on a given network fabric. The proposed fabric access technique can be deployed in clusters running distributed AI training or inference workloads. It allows a significant increase to the effective throughput of the interconnection fabric and consequently reduces the overall job completion time. This is of beneficial in the current scenario in which performance of AI applications is communication bound.

By knowing the size, route, and timing of data flows in advance, the network can allocate just the right amount of resources (e.g., bandwidth, buffer space, processing power) for each specific connection. This eliminates over-provisioning, where too many resources are reserved for traffic that doesn't need them, or under-provisioning, where resources are insufficient for the traffic, leading to congestion or data loss. By allocating only the necessary bandwidth for each flow, the network can better utilize available bandwidth for other tasks. Pre-allocating resources prevents multiple data flows from competing for the same resources at the same time, reducing network congestion and bottlenecks. By pre-allocating resources, the network can ensure that data flows receive immediate access to the required resources as soon as they are needed. This reduces latency (delay) and jitter (variation in delay), as packets don't have to wait in queues or compete for bandwidth. When resources are pre-allocated, the network is better prepared to handle the traffic, reducing the likelihood of dropped packets, retransmissions, or delays. Knowing traffic demands ahead of time allows the network to intelligently schedule data flows, preventing congestion before it occurs. Congestion typically happens when too many data flows compete for limited resources, leading to packet loss, high latency, and degraded performance.

The benefits of the example approach using the three functionalities include reducing the completion time for data exchanges, while maximizing the utilization of network resources. This results in an additional advantage in terms of network efficiency, completion time, and effective throughput compared to traditional approaches based on opportunistic transmission, statistical multiplexing of packets, and congestion control. The example approach can be deployed in clusters running distributed AI training or inference workloads. The example approach allows for a significant increase in the effective throughput of the interconnection fabric and consequently reduces the overall job completion time.

Further benefits of the example approach using the three functionalities include reduced latency, optimal resource utilization, improved scalability, better quality of service (QoS), minimized network congestion, and enhanced predictability and planning.

Triggering a reservation request before the source end point is ready so that the reservation is complete before the source end point is ready, minimizes wait times between data readiness and network availability. This is particularly beneficial for latency-sensitive applications. This approach avoids unnecessary delays caused by resource reservation happening too late, improving the overall flow of data. Allocating network resources exactly when needed avoids the wasteful over-reservation of bandwidth, memory, and processing power. If network resources are held idle for too long, it can lead to bottlenecks elsewhere in the system. The approach maximizes the efficiency of network resource use by ensuring that network resources are only occupied when there's an immediate need for data transmission. With this dynamic allocation mechanism, networks can handle a higher volume of requests and scale efficiently as demand grows. In large-scale systems, such as data centers or cloud platforms, resource allocation becomes more predictable, reducing overhead and congestion. The system to dynamically adapt to changing traffic patterns without the need for static reservations, which may cause inefficiencies under varying load conditions. This method allows for fine-tuned QoS control. By accurately predicting and allocating resources, the network can meet strict QoS requirements for specific applications. Precise timing of resource reservations reduces the likelihood of multiple sources competing for the same network resources simultaneously. This helps in avoiding congestion, packet loss, and queuing delays. It also ensures that no data packet gets stuck in a congested state, improving overall throughput and stability. By utilizing estimations of data readiness and reservation times, the system provides a more predictable flow of traffic, making it easier to plan network upgrades, monitor performance, and predict potential failures.

In conclusion, the examples involve a reservation service that can be either centralized or distributed. Most fabrics already leverage controllers and in a possible implementation the reservation service can be collocated with the controller. In a possible implementation the controller is implemented in one or more dedicated systems connected to the network. In another possible implementation the controller is implemented in one or more network nodes (switch or end host). In yet another possible implementation the reservation service is fully distributed and implemented in various network nodes. A common time reference among the end hosts is provided to trigger the beginning of transmission at the time reservation actually begins. A protocol between end hosts and the reservation service to request resource reservations and receive confirmation that resources have been reserved and when is also presented.

The examples further involve a method for achieving maximum network resource utilization while minimizing latency. The examples show how to allocate network resources exactly at the time when a source is ready to transmit. One example way of doing this is instrumenting the application that needs to use the communication services with a system that monitors the progress of the computation being performed and estimates the instant in time S at which the data to be transferred is going to be ready. The accuracy of such estimate is higher as the data availability time is approached. The examples show how to allocate network resources exactly at the time when a source is ready to transmit by estimating the time A needed to perform a resource reservation and triggering the resource reservation at the instant in time S-A, which provides a safety margin to take into account the uncertainty on S and A such that the allocation will be completed just before the data will actually be ready, i.e., the actual transmission time. The examples thus minimize the time during which resources are allocated, but not used (thus maximizing network efficiency) and the time between when the data is ready and when transmission begins (thus minimizing latency).

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

1. A method comprising:
estimating a data readiness time interval to define an estimated data readiness time interval;
estimating a network resource reservation readiness time interval;
issuing a resource reservation request at a time when the estimated data readiness time interval and the estimated network resource reservation readiness time interval are determined indicating a resource reservation can be completed before an end of the data readiness time interval, the time being determined from the estimated data readiness time interval and the estimated network resource reservation readiness time interval such that allocation of the network resources is completed immediately before data is ready for transmission; and
allocating network resources on an end-to-end path when a resource reservation confirmation is issued.

2. The method of claim 1, wherein the data readiness time interval represents an estimated remaining time until completion of an operation that generates data for transmission.

3. The method of claim 2, wherein the estimated data readiness time interval is based on knowledge of computations to be performed to complete the operation.

4. The method of claim 1, wherein the resource reservation confirmation is issued before a source end point is ready at the end of the data readiness time interval.

5. The method of claim 1, wherein the estimated data readiness time interval is determined by instrumentation of code to monitor progress of computations being performed.

6. The method of claim 1, wherein the estimated data readiness time interval and the estimated network resource reservation readiness time interval are embedded in an application using a compiler, a developer, or libraries, or are estimated via an algorithm embedded in an application using a compiler, a developer, or libraries.

7. The method of claim 1, wherein the resource reservation request is issued when the estimated data readiness time interval and the estimated network resource reservation readiness time interval match.

8. The method of claim 1, wherein the resource reservation request is issued when the estimated data readiness time interval and the estimated network resource reservation readiness time interval are close to take into account an error in the estimated data readiness time interval and the estimated network resource reservation readiness time interval.

9. The method of claim 1, wherein data is transmitted starting at a time at which the allocation of network resources on an end-to-end path begins, wherein a transmission time is determined according to a common time reference.

10. A system comprising:
a plurality of network resources providing data transmission between a plurality of source end points and a plurality of destination end points, wherein a first source end point transmits data to a first destination end point, at a common time reference, when a time at which the first source end point is ready to transmit the data is considered close by:
estimating a data readiness time interval to define an estimated data readiness time interval;
estimating a network resource reservation readiness time interval;
issuing a resource reservation request at a time when the estimated data readiness time interval and the estimated network resource reservation readiness time interval are determined indicating a resource reservation can be completed before an end of the data readiness time interval, the time being determined from the estimated data readiness time interval and the estimated network resource reservation readiness time interval such that allocation of the network resources is completed immediately before data is ready for transmission; and
allocating network resources on an end-to-end path when a resource reservation confirmation is issued.

11. The system of claim 10, wherein the data readiness time interval represents an estimated remaining time until completion of an operation that generates data for transmission and wherein the estimated data readiness time interval is based on knowledge of computations to be performed to complete the operation.

12. The system of claim 10, wherein the resource reservation confirmation is issued before a source end point is ready at the end of the data readiness time interval.

13. The system of claim 10, wherein the estimated data readiness time is determined by instrumentation of code to monitor progress of computations being performed.

14. The system of claim 10, wherein the estimated data readiness time interval and the estimated network resource reservation readiness time interval are embedded in an application using a compiler, a developer, or libraries, or are estimated via an algorithm embedded in an application using a compiler, a developer, or libraries.

15. The system of claim 10, wherein the resource reservation request is issued when the estimated data readiness time interval and the estimated network resource reservation readiness time interval match.

16. The system of claim 10, wherein the resource reservation request is issued when the estimated data readiness time interval and the estimated network resource reservation readiness time interval are close to take into account an error in the estimated data readiness time interval and the estimated network resource reservation readiness time interval.

17. The system of claim 10, wherein data is transmitted starting at a time at which the allocation of network resources on an end-to-end path begins, wherein a transmission time is determined according to a common time reference.

18. A system comprising:
network resources configured to be allocated, at a common time reference between source and destination end points, on an end-to-end path by at least:
estimating a data readiness time interval; and
issuing a resource reservation request when a time at which a resource reservation can be completed is close to the estimated data readiness time interval, the time being determined from the estimated data readiness time interval and an estimated network resource reservation readiness time interval such that allocation of the network resources is completed immediately before data is ready for transmission.

19. The system of claim 18, wherein the data readiness time interval represents an estimated remaining time until completion of an operation that generates data for transmission and wherein the estimated data readiness time interval is based on knowledge of computations to be performed to complete the operation.

20. The system of claim 18, wherein the estimated data readiness time interval and the estimated network resource reservation readiness time interval are embedded in an application using a compiler, a developer, or libraries, or are estimated via an algorithm embedded in an application using a compiler, a developer, or libraries.
